(19) United States
(12) Patent Application Publication
(10) Pub. No.: US 2026/0079613 A1
(43) Pub. Date: Mar. 19, 2026

(54) DATA PROCESSING METHOD, ELECTRONIC DEVICE AND STORAGE MEDIUM

(71) Applicant: Beijing Zitiao Network Technology Co., Ltd., Beijing (CN)

(72) Inventors: Shihong LIN, Beijing (CN); Xue CHEN, Beijing (CN)

(21) Appl. No.: 19/109,519

(22) PCT Filed: Dec. 12, 2023
(86) PCT No.: PCT/CN2023/138128

§ 371 Date: Mar. 6, 2025

(30) Foreign Application Priority Data
Dec. 23, 2022 (CN) 202211667507.3

(51) Int. Cl. G06F 3/0484; G06F 3/0482

(52) U.S. Cl. CPC G06F 3/0484; G06F 3/0482

(57) ABSTRACT

Embodiments of the present disclosure provide a data processing method, an electronic device, and a storage medium. The method includes: in response to a view creation operation, editing at least two target data sources and at least one work item corresponding to the target data sources; retrieving associated data corresponding to the at least one work item associated with the at least two target data sources; and determining and displaying a target view based on the associated data and a target view display type that is predetermined.

The present application claims priority of the Chinese Patent Application No. 202211667507.3, filed on Dec. 23, 2022, and the disclosure of which is incorporated herein by reference in its entirety as part of the present application.

### TECHNICAL FIELD

Embodiments of the present disclosure relate to a data processing method and apparatus, an electronic device, and a storage medium.

### BACKGROUND

For various types of application software, a large amount of project information is usually involved in a process of performing business processing based on any application software. At this time, a user may need to manage projects under some applications.

However, when performing project management, the user can only manually select a certain application, and then view and manage all projects in the application. This management method has a problem of low management efficiency.

### SUMMARY

The present disclosure provides a data processing method and apparatus, an electronic device, and a storage medium, to implement data management and display across applications, and enable users to clearly learn project information between applications based on a displayed view, so as to implement joint management of a plurality of applications, improve the management efficiency, and achieve a technical effect of meeting management needs of users.

In a first aspect, an embodiment of the present disclosure provides a data processing method, including:

editing at least two target data sources and at least one work item corresponding to the target data sources in response to a view creation operation;

retrieving associated data corresponding to the at least one work item associated with the at least two target data sources; and

determining and displaying a target view based on the associated data and a target view display type that is predetermined.

In a second aspect, an embodiment of the present disclosure further provides a data processing apparatus, including:

a target data source determination module, configured to edit at least two target data sources and at least one work item corresponding to the target data sources in response to a view creation operation;

an associated data determination module, configured to retrieve associated data corresponding to the at least one work item associated with the at least two target data sources; and

a target view display module, configured to determine and display a target view based on the associated data and a target view display type that is predetermined.

In a third aspect, an embodiment of the present disclosure further provides an electronic device, including:

one or more processors; and

a storage apparatus, configured to store one or more programs,

where the one or more programs, when executed by the one or more processors, cause the one or more processors to implement the data processing method according to any one of the embodiments of the present disclosure.

In a fourth aspect, an embodiment of the present disclosure further provides a storage medium including computer-executable instructions, where the computer-executable instructions, when executed by a computer processor, cause the data processing method according to any one of the embodiments of the present disclosure to be implemented.

### BRIEF DESCRIPTION OF DRAWINGS

The above and other features, advantages and aspects of various embodiments of the present disclosure become more apparent with reference to the following specific embodiments and in conjunction with the drawings. Throughout the drawings, the same or similar reference numerals denote the same or similar elements. It should be understood that the drawings are schematic and the components and elements are not necessarily drawn to scale.

FIG. 1 is a schematic flowchart of a data processing method provided by an embodiment of the present disclosure;

FIG. 2 is a schematic diagram of an edit page provided by an embodiment of the present disclosure;

FIG. 3 is a schematic flowchart of a data processing method provided by an embodiment of the present disclosure;

FIG. 4 is a schematic flowchart of a data processing method provided by an embodiment of the present disclosure;

FIG. 5 is a schematic diagram of a data range selection page provided by an embodiment of the present disclosure;

FIG. 6 is a schematic flowchart of a data processing method provided by an embodiment of the present disclosure;

FIG. 7 is a schematic diagram of an aggregated field configuration page provided by an embodiment of the present disclosure;

FIG. 8 is a schematic diagram of a view display page provided by an embodiment of the present disclosure;

FIG. 9 is a schematic diagram of a view display page provided by an embodiment of the present disclosure; and

FIG. 10 is a schematic structural diagram of an electronic device provided by an embodiment of the present disclosure.

### DETAILED DESCRIPTION

Embodiments of the present disclosure will be described in more detail below with reference to the drawings. Although some embodiments of the present disclosure are shown in the drawings, it should be understood that the present disclosure may be implemented in various forms, and should not be construed as limited to the embodiments set forth herein. On the contrary, these embodiments are provided for a more thorough and complete understanding of the present disclosure. It should be understood that the drawings and embodiments of the present disclosure are only for illustrative purposes, and are not intended to limit the protection scope of the present disclosure.

It should be understood that the various steps described in the method implementations of the present disclosure may be performed in different orders, and/or performed in parallel. Furthermore, the method implementations may include additional steps and/or omit performing the illustrated steps. The protection scope of the present disclosure is not limited in this respect.

The term “include/include” and variations thereof used herein are open-ended inclusions, namely, “include/include but not limited to”. The term “based on” is “at least partially based on”. The term “an embodiment” means “at least one embodiment”. The term “another embodiment” means “at least one additional embodiment”. The term “some embodiments” means “at least some embodiments”. Relevant definitions of other terms will be given in the description below.

It should be noted that concepts such as “first” and “second” mentioned in the present disclosure are only used to distinguish between different apparatuses, modules, or units, and are not used to limit a sequence of functions performed by these apparatuses, modules, or units or interdependence between the functions.

It should be noted that modifications of “one” and “a plurality of” mentioned in the present disclosure are illustrative rather than restrictive. Those skilled in the art should understand that unless otherwise clearly indicated in the context, they should be understood as “one or more”.

The names of messages or information exchanged between a plurality of apparatuses in the implementations of the present disclosure are only for illustrative purposes, and are not intended to limit the scope of the messages or information.

It should be understood that before using the technical solutions disclosed in the embodiments of the present disclosure, the user should be informed of the type of personal information involved in the present disclosure, the scope of use, the usage scenario, and the like through an appropriate manner in accordance with relevant laws and regulations, and the user's authorization should be obtained.

For example, when the receiving of the active request from the user is responded to, prompt information is sent to the user, so as to explicitly prompt the user that the operation requested to be performed by the user will require the acquisition and use of the user's personal information. Thus, the user can independently choose whether to provide the personal information to the software or hardware such as the electronic device, the application, the server, or the storage medium that performs the operation of the technical solution of the present disclosure, according to the prompt information.

As an optional but non-limiting implementation, for example, the manner of sending the prompt information to the user in response to the receiving of the active request from the user may be a manner of a pop-up window, and the prompt information may be presented in text in the pop-up window. In addition, the pop-up window may also include a selection control for the user to select “agree” or “disagree”to provide the personal information to the electronic device.

It can be understood that the above process of notifying and acquiring the user's authorization is only illustrative, and does not constitute a limitation on the implementations of the present disclosure. Other manners that meet the requirements of relevant laws and regulations may also be applied to the implementations of the present disclosure.

It can be understood that the data involved in the technical solution (including but not limited to the data itself, the acquisition or use of the data) should comply with the requirements of corresponding laws and regulations and related provisions.

Before introducing the technical solutions of the present disclosure, an application scenario may be exemplarily described. The technical solutions of the embodiments of the present disclosure may be applied to any scenario where data needs to be displayed in a view. Exemplarily, in a process of performing business processing by various types of application software, each application may include a plurality of business projects, and each project may involve a large amount of project data. When a plurality of applications are managed, a common management method can only view and manage project data in one application at a time, and the data association between the applications is poor, which makes it difficult for users to uniformly manage the plurality of applications. At this time, based on the technical solutions of the embodiments of the present disclosure, after a view creation function is initiated, project data corresponding to a plurality of projects under each application may be retrieved, and the project data of the plurality of applications may be integrated and displayed in the form of a view, so as to implement project data display across applications, and enable users to clearly learn the project information between applications based on the displayed view, thereby implementing joint management of the plurality of applications.

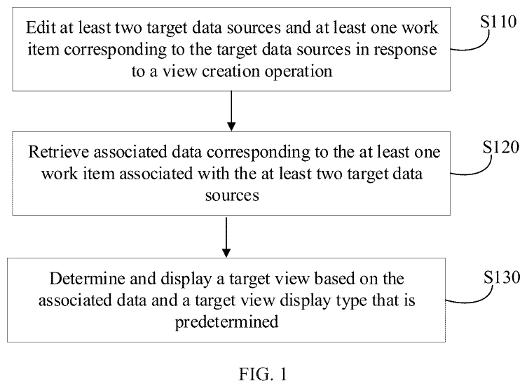

FIG. 1 is a schematic flowchart of a data processing method provided by an embodiment of the present disclosure. The embodiment of the present disclosure is applicable to a scenario where a plurality of applications are jointly managed, and the method may be executed by a data processing apparatus, which may be implemented in the form of software and/or hardware, optionally, by an electronic device, which may be a mobile terminal, a PC, a server, etc.

As shown in FIG. 1, the method includes the following steps.

S110: edit at least two target data sources and at least one work item corresponding to the target data sources in response to a view creation operation.

The view creation operation may be triggered by the user when the user needs to create a view, and an operation form of the view creation operation may be one of clicking, touching, sliding or dragging. For example, a view creation control may be displayed on a system interface, and the user may trigger a function of creating a view corresponding to the control by clicking the creation control or using a keyboard to input a shortcut key of the creation control, and the triggering operation is the view creation operation. A target data source may represent an application or software, such as a shopping application, a chat application, a delivery application, an information application, etc. Each application may include a plurality of projects, such as a game project, an audio production project, a shopping project, a question answering project, etc. A work item may refer to an item planned for a project or an item that needs to be traced, such as a project requirement item, a defect item, a design review item, a test item, etc.

In practical applications, a control for creating a view may be pre-developed, and when it is detected that the user triggers the control, the view creation operation may be responded to. The user may select a data source required for the view creation, and the data source selected by the user may be used as the target data source. The user may also select a task under the target data source and use the selected task as the work item.

In this embodiment, after responding to the view creation operation, an edit page may be displayed, so as to edit the at least two target data sources and the at least one work item corresponding to the target data sources in the edit page.

The edit page includes at least one of a view name edit control, a data source edit control, a data range selection control, and a view display type selection control. The data range selection control includes a work item selection sub-control. The view name edit control may be a touchable component for editing a view name, for example, may be an edit box to enter the view name in the edit box. The data source edit control may be a touchable component for selecting a data source, for example, may be an edit box or a drop-down list, to select the corresponding data source in the drop-down list. The data range selection control may be a touchable component for selecting an additional item, where the additional item is related to information required for creating a view, for example, the additional item may be adding a work item, adding a view, adding an instance, etc. The work item selection sub-control refers to a touchable component for selecting a work item. The view display type selection control may be a touchable component for selecting a view display type, and the view display type may include a plurality of types, such as a column chart, a bar chart, a pie chart, a line chart, a scatter chart, and the like. It should be noted that the view name edit control, the data source edit control, the data range selection control, and the view display type selection control may be arranged in any area of the edit page, and may be displayed in any form, which is not specifically limited in the embodiments of the present disclosure.

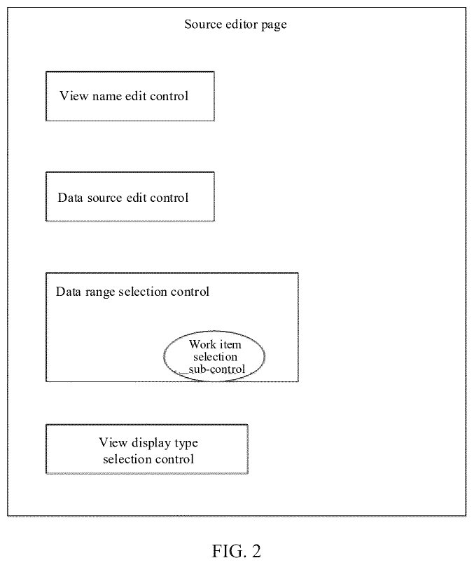

Specifically, a control for triggering the creation of the view may be pre-set, and when it is detected that the user triggers the control, an edit page may be popped up or switched to on a display interface. The edit page may be displayed in full screen, or may be displayed at a preset display ratio (such as 80% or 90% of the full screen). Exemplarily, reference may be made to FIG. 2, which may be a schematic diagram of an edit page, and the edit page includes a view name edit control, a data source edit control, a data range selection control, and a view display type selection control. After the edit page is displayed, at least one work item and associated data may be determined based on edit operations on the edit page. For example, the user selects a target data source and at least one work item corresponding to the target data source by triggering various controls in the edit page, so as to subsequently retrieve associated data corresponding to the at least one work item associated with the target data source. This arrangement has the following advantage: the user may use various configuration controls to determine the project information under the plurality of data sources that needs to be viewed as required, and select a view display type for drawing the view, so as to draw a view that meets the user's needs, thereby improving the user experience.

S120: retrieve associated data corresponding to the at least one work item associated with the at least two target data sources.

The associated data may be data for characterizing the execution of the corresponding work item. For example, the associated data may include a project name, requirement content, defect content, and the like.

In this embodiment, after the at least two target data sources and the at least one work item corresponding to each target data source are edited, task data corresponding to each work item under each target data source may be retrieved by using an interface as the associated data, so as to create a corresponding view based on the associated data. A data retrieval control may also be pre-configured, and when a trigger operation of the control is detected, the associated data of the corresponding work item is retrieved from different target data sources.

S130: determine and display a target view based on the associated data and a target view display type that is predetermined.

The target view display type may be selected according to the needs of the user, or may be automatically configured by the system.

Specifically, after the associated data under the plurality of target data sources is obtained, view drawing may be performed on the associated data according to the target view display type, so as to generate the target view. For example, when the target view display type is a line chart, the target view is a line chart that may represent an overall condition of the associated data. The target view may be displayed in a set area of a system page, so that the user may view the work data under the plurality of target data sources by browsing the target view.

In the technical solutions of the embodiment of the present disclosure, the at least two target data sources and the at least one work item corresponding to the target data sources are edited in response to the view creation operation; the associated data corresponding to the at least one work item associated with the at least two target data sources is retrieved; and the target view is determined and displayed based on the associated data and the target view display type that is predetermined. Therefore, the problem of low management efficiency caused by viewing the project information under each application one by one for project management is solved, and by retrieving the associated data corresponding to the plurality of work items under each application after the view creation function is initiated, and integrating and displaying the associated data of the plurality of applications in the form of a view, data display across applications is implemented, and users can clearly learn the project information between the applications based on the displayed view, so as to implement the joint management of the plurality of applications, improve the management efficiency, and achieve a technical effect of meeting the management needs of the users.

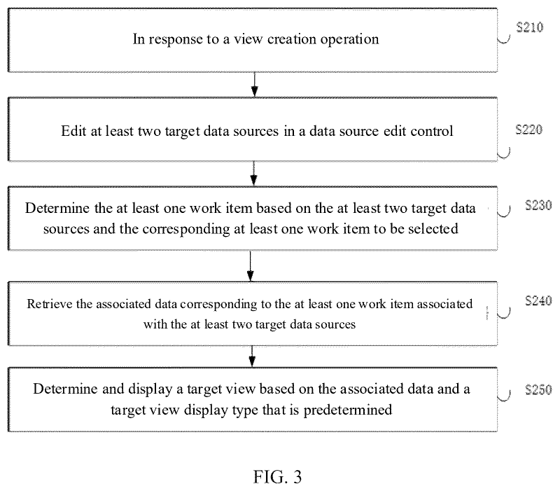

FIG. 3 is a schematic flowchart of a data processing method provided by an embodiment of the present disclosure. On the basis of the foregoing embodiments, when editing at least two target data sources and at least one work item corresponding to the target data sources, the target data sources and the at least one work item corresponding to each target data source may be edited through a trigger operation on a data source edit control in the displayed edit page. For the specific implementation, reference may be made to the technical solutions of this embodiment. Technical terms the same as or corresponding to the above embodiments are not repeated herein.

As shown in FIG. 3, the method specifically includes the following steps:

S210: in response to a view creation operation.

S220: edit at least two target data sources in a data source edit control.

In this embodiment, when it is detected that the user triggers the data source edit control, a data source edit function may be initiated, and then data source information is edited and input in the data source edit control, and the input data source information is used as the target data source. For example, when the data source edit control is in the form of a drop-down list, when the control is triggered, a data source selection list may be displayed, and the data source selection list includes a plurality of data source labels to be selected. Each data source label may represent a unique application, such as the name of the application, for example, application 1, application 2, application 3, and so on. The user may select, in the list, an application that he/she wants to manage. For example, the user may select, through a trigger operation, the application to which the data source label in the list belongs as the target data source. Alternatively, the user may enter search information in a search box, and match the input search information with each data source label in the list, and use the application to which the data source label matching the search information belongs as the target data source. Alternatively, when the data source edit control is in the form of an edit box, controls of a plurality of data source labels may be pre-configured in the data source edit control and displayed on the page. When the user clicks a certain label control, it is considered that the user selects the data source label corresponding to the control, and the application corresponding to the data source label is used as the target data source. When the user clicks the control again, it may be considered that the user cancels the selection of the data source label of the control, that is, the application corresponding to the data source label is not the target data source at this time.

Exemplarily, the user may enter a multi-selection editor by clicking the data source edit control, and options in the multi-selection editor may include all data sources and/or respective data sources that the user currently has permission to access. The data sources may be sorted according to a priority of recent access being greater than alphabetical order, so that the user selects the target data sources from the respective data sources that the user currently has permission to access. For example, the user may enter a data source name in the edit box, perform a full word match and a case-insensitive fuzzy search on the input name and fields of the data sources with permission to access, and search for a data source matching the input name as the target data source. It should be noted that after entering the multi-selection editor, it is also supported to default to select a current data source, support full selection, partial selection, deselection, clear selection, keep selection, and the like. For example, when a data source is not selected by default, information of the data source does not appear in a subsequently created view, and the data source does not be displayed on the edit page. When a data source is selected by default, the data source is saved and displayed on the edit page.

S230: determine the at least one work item based on the at least two target data sources and the corresponding at least one work item to be selected.

The work item to be selected may be a pre-configured work item that may be selected. The work items to be selected under each target data source may be the same or different.

In practical applications, at least one work item to be selected under each data source may be displayed, and the user may trigger to select, from the displayed work items to be selected, work items that need to be viewed and managed. Accordingly, at least one work item may be determined. It should be noted that when determining the work item, there may be some work items that are not work items under the target data source selected by the user. At this time, the target data source may be compared with the data source to which the work item selected by the user belongs, and the work item matching the target data source may be selected from the work items selected by the user, so as to improve the accuracy of work item determination.

Specifically, the implementation of determining the at least one work item based on the at least two target data sources and the corresponding at least one work item to be selected may be: determining the at least one work item based on the at least two target data sources and a target data source to which the at least one work item to be selected belongs.

In this embodiment, the target data source to which the work item selected by the user belongs may be matched with the edited target data source, to obtain the work item selected by the user under the edited target data source. At this time, these obtained work items are used as work item information required for constructing a subsequent view, so as to improve the adaptability between the construction of the view and the user's needs.

In order to enable the user to clearly learn the target data source and work item selected in the last view creation, after the at least two target data sources and the corresponding at least one work item are determined, the target data source and the corresponding at least one work item may be stored as a piece of historical data, to display the historical data in response to the view creation operation being received again.

Specifically, the edited target data sources and the corresponding at least one work item may be spliced and integrated to obtain a piece of integrated data, and the integrated data may be stored as a piece of historical data in a preset position. Subsequently, when receiving the view creation operation again, the system may display the historical data on the page in any form such as text, button, icon, picture, etc., so that the user may see which target data sources and work items were selected in the last view creation.

S240: retrieve the associated data corresponding to the at least one work item associated with the at least two target data sources.

S250: determine and display a target view based on the associated data and a target view display type that is predetermined.

In the technical solutions of the embodiment of the present disclosure, at least two target data sources are edited in the data source edit control, and then at least one work item is determined based on the at least two target data sources and the corresponding at least one work item to be selected, so that the user can select the target data source to be managed as required, and view the work item under the target data source, thereby improving the user experience and meeting the management needs of the user.

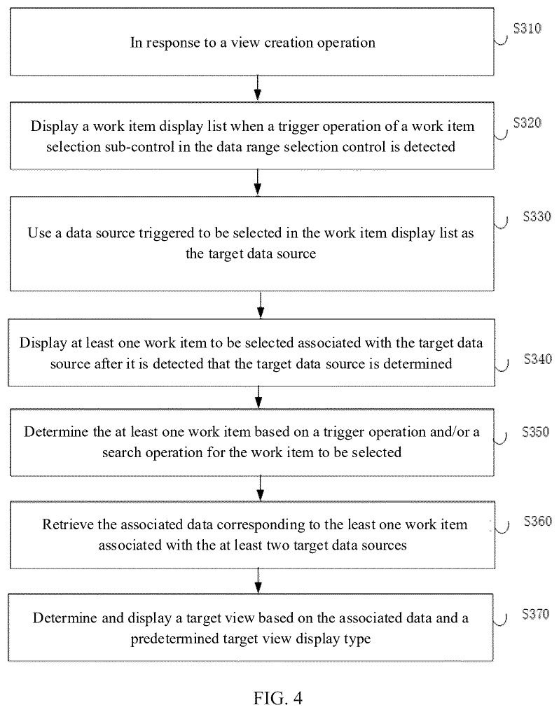

FIG. 4 is a schematic flowchart of a data processing method provided by an embodiment of the present disclosure. On the basis of the foregoing embodiments, when editing at least two target data sources and at least one work item corresponding to the target data sources, the target data sources and the at least one work item corresponding to each target data source may be edited and determined through a trigger operation on a data range selection control in the displayed edit page. For the specific implementation, reference may be made to the technical solutions of this embodiment. Technical terms the same as or corresponding to the above embodiments are not repeated herein.

As shown in FIG. 4, the method specifically includes the following steps:

S310: in response to a view creation operation.

S320: display a work item display list in response to a trigger operation of the work item selection sub-control in the data range selection control being detected.

The work item display list displays at least one data source with access permission and a corresponding work item to be selected. The display information in the work item display list is related to users who can use a view creation function, and the permission of each user to manage a data source may be different. Therefore, the data source with access permission and the corresponding work item to be selected in the work item display list corresponding to each user may also be different. For example, a work item display list B corresponding to a user A includes a data source C that may be accessed, corresponding work items C1, C2, C3, a data source D and corresponding work items D1, D2. A work item display list B corresponding to a user B includes a data source C that may be accessed, corresponding work items C1, C3, a data source E and corresponding work items E1, E2.

Specifically, the user may click the data range selection control, or use the keyboard to input a shortcut key corresponding to the data range selection control, to trigger the control and initiate the function of data range selection. At this time, the work item display list corresponding to the user may be displayed. A data source and a work item to be selected displayed in the work item display list are with access permission when they can be triggered by the user, and are without access permission when they cannot be triggered by the user. Therefore, data for drawing the view may be selected from the displayed data source and the corresponding work item. It should be noted that information without access permission in the work item display list may be displayed distinguishably from information with access permission, so that the user can clearly learn which data sources and work items he/she can manage, and perform trigger operations on the data sources and work items that can be managed, thereby improving the convenience of data management.

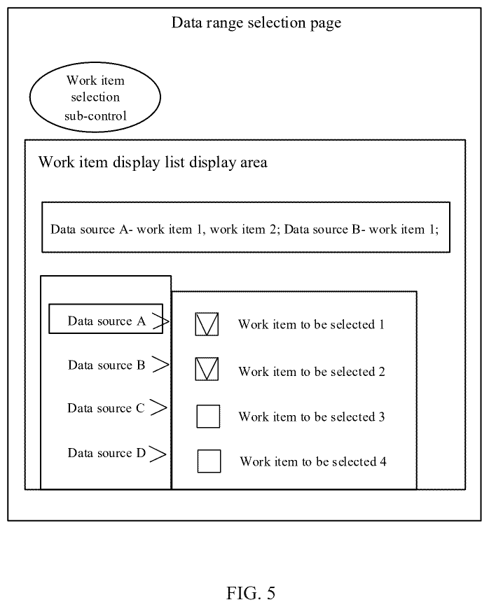

Exemplarily, when it is detected that the user triggers the data range selection control, the data range selection page shown in FIG. 5 may be displayed. The user may display the work item display list in the display area of the work item display list through a trigger operation of the work item selection sub-control.

S330: use a data source triggered to be selected in the work item display list as the target data source.

Specifically, the user may select, in the work item display list through a trigger operation, a data source that needs to be managed, and the selected data source may be used as the target data source.

Exemplarily, continuing to refer to FIG. 5, after the user clicks the data source A in the work item display list, the data source A is displayed distinguishably from the data source B, the data source C, and the data source D in the list, indicating that the data source A is selected. The selected data source A may be used as the target data source.

S340: display at least one work item to be selected associated with the target data source after it is detected that the target data source is determined.

In this embodiment, when the user clicks a certain data source in the work item display list, it is considered that it is detected that the target data source is determined. At this time, at least one work item to be selected corresponding to the target data source may be displayed, so that the user selects, from the displayed work items to be selected, the work item that he/she wants to manage.

Exemplarily, still referring to FIG. 5, after the user clicks the data source A, work items to be selected 1, 2, 3, 4, and the like under the data source A may be displayed at the position of the data source A. Then, when the user clicks the data source B, the work items to be selected under the data source A are collapsed, and the work items to be selected of the data source B are displayed. It should be noted that after the button corresponding to the target data source is clicked, a multi-selection editor is entered, and work items in the target data source may be displayed according to work item labels. When the number of the target data source is 1, there may be only one level of work item with the target data source. When the number of the target data source is greater than 1, a space level selection is added, and there are work items at each level of the target data source.

S350: determine the at least one work item based on a trigger operation and/or a search operation for the work item to be selected.

In practical applications, after at least one work item to be selected associated with a certain target data source is displayed, a work item that needs to be viewed may be selected by triggering an identifier control corresponding to the work item to be selected. A search bar may also be pre-configured on the display page. Work item information may be input in the search bar, and when a confirm control is triggered, a search algorithm (such as full word matching and case-insensitive fuzzy matching) is used to search for a work item matching the input information from the at least one displayed work item to be selected, and the work item with the highest matching degree may be used as the work item that needs to be viewed. Alternatively, the searched work item may be displayed, for example, in the form of a list, and which one or more of the work items are to be viewed may be determined through a trigger operation of the user.

Exemplarily, still referring to FIG. 5, the check box corresponding to the displayed work item to be selected may be checked, and the first work item may be selected by default, full selection, partial selection, deselection, and the like may be supported. It should be noted that when the number of the target data source is 1, a multi-selection drop-down list may be set, and the list displays all work items that are not disabled under the corresponding target data source. The display sequence of work items may be the same as the sequence of work items in the background, so as to facilitate the user to clearly understand the project flow. When the number of the target data source is greater than 1, cascade multi-selection may be set. In a manner of selecting a data source first and then selecting a work item, a data source may be displayed according to a content of the data source and a sequence of the selected data source. A work item may be displayed in a corresponding data source in a manner of displaying all enabled work items with permission to access, and the display sequence may be the same as the sequence of work items in the background.

In order to enable the user to clearly browse the edited target data source and work item, and improve the display effect, after the at least two target data sources and the corresponding at least one work item are determined, the target data source and the corresponding at least one work item may be displayed. The display form may be data source name+work item type+work item name. As shown in FIG. 5, the target data source and the corresponding at least one work item may be displayed as data source A-work item 1, work item 2; data source B-work item 1. It should be noted that during display, group display may also be performed based on the number of selected items. For example, when the number of work items under the target data source exceeds a preset number (such as 3), truncation may be performed according to a multi-selection label component style, and every 3 work items are displayed as a group. In order to further improve the display effect, an animation display with a mouse over effect may also be used.

It should be noted that when the target data source and the work item are edited based on the data range selection control, the determined target data source and the corresponding work item may be verified. For example, null value verification is performed. When the target data source and the work item are empty, the view drawing operation is prohibited, and animation prompt information is displayed, such as “Please complete required items first”, and prompt information such as required item errors is displayed in the data source selection area.

In this embodiment, after at least two target data sources and the corresponding at least one work item are determined, the target data source and the corresponding at least one work item may also be stored as a piece of historical data, to display the historical data in response to the view creation operation being received again.

S360: retrieve the associated data corresponding to the least one work item associated with the at least two target data sources.

S370: determine and display a target view based on the associated data and a target view display type that is predetermined.

In the technical solutions of the embodiment of the present disclosure, when the trigger operation of the work item selection sub-control in the data range selection control is detected, the work item display list is displayed, and then the data source is triggered to be selected in the work item display list, to obtain the target data source. After the target data source is determined, at least one work item to be selected associated with the target data source is displayed, and then the at least one work item is determined based on the trigger operation and/or the search operation for the at least one work item to be selected. By hierarchically displaying the data source and the work item, the user can browse the hierarchical relationship between the data source and the work item more clearly and intuitively, to implement hierarchical management of the data source and the work item, improve the convenience of data management, and enhance the user experience.

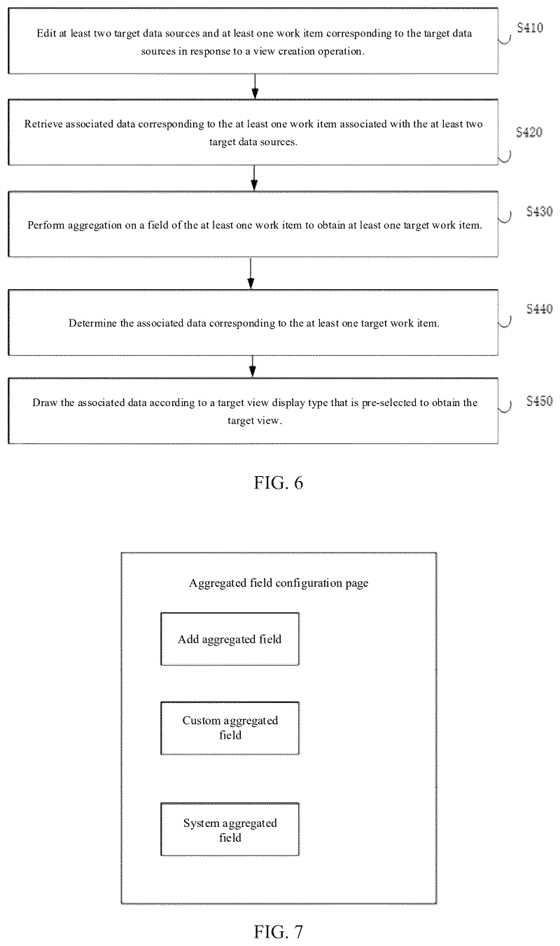

FIG. 6 is a schematic flowchart of a data processing method provided by an embodiment of the present disclosure. On the basis of the foregoing embodiments, when determining the target view based on the associated data and the target view display type that is predetermined, aggregation may also be performed on the field of the work item to obtain an aggregated work item, so as to retrieve the associated data of the aggregated work item to draw the target view. For the specific implementation, reference may be made to the technical solutions of this embodiment. Technical terms the same as or corresponding to the above embodiments are not repeated herein.

As shown in FIG. 6, the method specifically includes the following steps.

S410: edit at least two target data sources and at least one work item corresponding to the target data sources in response to a view creation operation.

S420: retrieve associated data corresponding to the at least one work item associated with the at least two target data sources.

S430: perform aggregation on a field of the at least one work item to obtain at least one target work item.

The field may be used to characterize the uniqueness of the work item, such as may be a work item name, ID, or may also be a field composed of numbers, letters, identifiers, etc.

It should be noted that in an actual scenario, each work item under the same data source or different data sources may have the same name or different names. The different names may be caused by various factors such as a service condition of the data source or a naming habit of technicians, but the meanings of the actual work items may be the same. In order to better manage the work item, work items with the same meaning may be unified for unified management.

Specifically, aggregation may be performed on the field of the work item selected by the user to obtain at least one aggregated field, and the aggregated field may be used to represent the target work item. In this way, the system may know which work items are under the data source corresponding to the target work item, as long as the target work item is learned. It should be noted that there may be at least two implementations of performing aggregation on the field of the at least one work item to obtain the at least one target work item, which will be described below.

One implementation may be performing aggregation on the field of the at least one work item according to a preset aggregation rule to obtain the at least one target work item.

In this embodiment, the aggregation rule may refer to a processing method for aggregating a plurality of fields into a class. The aggregation rule may include a plurality of types, such as a method for aggregating words with semantic similarity higher than a preset threshold into a class. For example, in a process of performing aggregation on the field of the at least one work item according to the aggregation rule, the semantic similarity between every two fields may be calculated, the fields with semantic similarity higher than the preset threshold may be aggregated into a class, and a plurality of classes may be divided. A unique field may be set for each class as a field of the target work item. Alternatively, it may also be pre-configured which work item fields may be grouped into a class, and an association relationship between the fields grouped into a class may be established. An aggregation rule may be generated according to the association relationship, so that the work item fields are aggregated according to the association relationship between the fields in the aggregation rule, and the fields that satisfy the association relationship are aggregated into a class. Specifically, the fields with the association relationship are aggregated according to the aggregation rule, and the fields with the association relationship may be unified into a unique field as the field of the target work item. The field may be any of the aggregated fields, or may be a pre-configured unique field. For example, it is pre-configured that work items “requirement”, “task”, “instance”, “project”, etc. have an association relationship, and the aggregated field of these fields may be represented by “field A”. When aggregation is performed on the at least one work item, these fields with the association relationship are extracted to aggregate, and the field A is used as the target work item. This arrangement has the following advantage: it is convenient to perform unified management on the work items under the same data source or different data sources, and the management effect is improved.

It should be noted that when the aggregated field is configured, the aggregated field may be configured through a drop-down list of a filter option of a cascade single selection. When the data source includes a work item that satisfies cross data source & same data source, a work item field and a data source name (which may be sorted according to a selection sequence) in the data source may be selected firstly; then a work item field (which may be a work item name) is selected, and the selected work item field may be sorted according to a work item sequence configured in the background in the data source; finally, the work item field is clicked, and information under a corresponding work item is displayed, where columns may be divided according to a field/resource, and then according to a current selection being better than alphabetical order. When the data source includes a work item that satisfies cross data source, and there is no cross work item under the same data source, a work item field and a data source name (which may be sorted according to a selection sequence) in the data source may be selected firstly; then the work item field is clicked, and information under a corresponding work item is displayed, where columns may be divided according to a field/resource, and then according to a current selection being better than alphabetical order. When the data source does not include a work item that satisfies cross data source, and there is a work item that needs to be aggregated under the same data source, a work item field (which may be a work item name) may be selected firstly, and the selected work item field may be sorted according to a work item sequence configured in the background in the data source; finally, the work item field is clicked, and information under a corresponding work item is displayed, where columns may be divided according to a field, and then according to a current selection being better than alphabetical order. Exemplarily, reference may be made to the aggregated field configuration page shown in FIG. 7, and the user may select the aggregated field by clicking an “add aggregated field” control, a “custom aggregated field” control, and a “system aggregated field” control. The “add aggregated field” control refers to a touchable component for performing a function of searching for an aggregated field. When the “custom aggregated field” control and the “system aggregated field” control are triggered, at least one field that can be aggregated may be displayed, and each field corresponds to one work item.

Another implementation may be determining a fused field based on a trigger operation on an aggregated field of the at least one work item; and determining the at least one target work item based on the fused field.

The trigger operation may include one of operations such as clicking, touching, sliding, and dragging.

Specifically, after the at least one work item is determined, the user may also determine which work items have the same meaning, that is, the field aggregation may be performed according to the user's needs, that is, the field aggregation may be performed according to a trigger operation of the user. The user may select a plurality of times, and each time a field of a group of work items that need to be aggregated may be selected. When a trigger of a confirm control is detected, the fields of those work items in the same group may be aggregated into one field, and the aggregated field may be used as the fused field. Accordingly, a plurality of fused fields may be obtained, and each fused field may be used as a target field of a target work item, so as to characterize the target work item based on the target field. This arrangement has the following advantage: the fields of the plurality of work items may be custom aggregated according to the user's own management needs, and the target work item field that meets the user's habits may also be generated, which also makes the displayed view clearer and more comprehensible for the user who performs the operation.

S440: determine the associated data corresponding to the at least one target work item.

Specifically, work data under each target work item may be retrieved, that is, the associated data corresponding to each target work item is obtained, to draw a view based on the associated data.

S450: draw the associated data according to the target view display type that is pre-selected to obtain the target view.

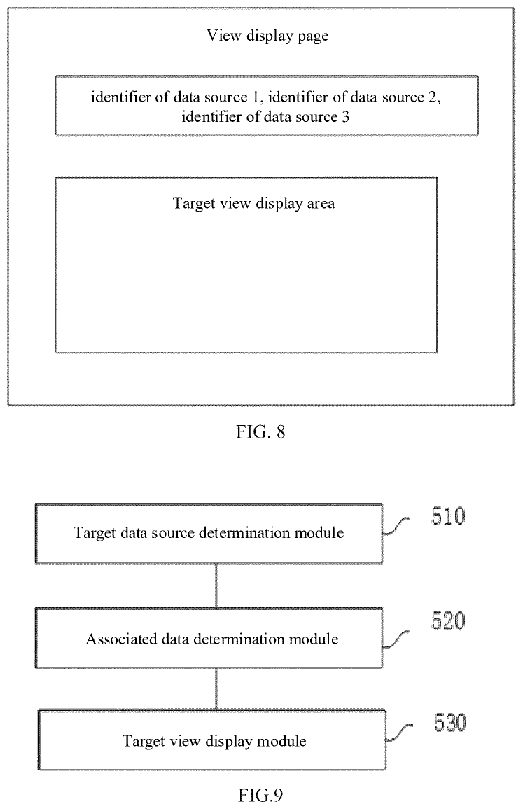

In this embodiment, when the user clicks the view display type selection control, a view display type selection function may be initiated, and then a plurality of view display types (such as a column chart, a bar chart, a pie chart, a line chart and a scatter chart, etc.) may be displayed, and the triggered view display type may be used as the target view display type. Further, the associated data under the plurality of target data sources may be used as content data of the view corresponding to the target view display type, and the target view capable of expressing the associated data information may be drawn, so that the user may view the work data under the plurality of target data sources by browsing the target view. It should be noted that in order to enable the user to clearly learn which target data sources are managed in the target view, the identifier of the at least two target data sources may be displayed in the target view. The identifier of the data source may be used to characterize the uniqueness of the target data source, and the display form of the identifier of the data source may be text, numbers, buttons, icons, pictures, etc. Exemplarily, reference may be made to FIG. 8, which may be a view display page. The identifier of the data source 1, the identifier of the data source 2, and the identifier of the data source 3may be displayed on the view display page, and the target view corresponding to the associated data of the target work item of the target data source pair to which the identifier of the data source 1, the identifier of the data source 2, and the identifier of the data source 3 belong is displayed in the target view display area.

In the technical solutions of the embodiment of the present disclosure, the field of at least one work item is aggregated to obtain at least one target work item, and then the associated data corresponding to the at least one target work item is determined, and the associated data is drawn according to the target view display type that is pre-selected to obtain the target view. By using the target work item to represent the multiple work items, the readability and conciseness of the target view are improved, so that the user can learn the data information of the plurality of work items through the displayed target view, and the joint management of the plurality of work items is implemented, thereby improving the management effect.

FIG. 9 is a schematic structural diagram of a data processing apparatus provided by an embodiment of the present disclosure. As shown in FIG. 9, the apparatus includes: a target data source determination module 510, an associated data determination module 520, and a target view display module 530.

The target data source determination module 510 is configured to edit at least two target data sources and at least one work item corresponding to the target data sources in response to a view creation operation.

The associated data determination module 520 is configured to retrieve associated data corresponding to the at least one work item associated with the at least two target data sources.

The target view display module 530 is configured to determine and display a target view based on the associated data and a target view display type that is predetermined.

On the basis of the above technical solutions, the apparatus further includes: an edit page display module.

The edit page display module is configured to display the edit page, where the edit page includes at least one of a view name edit control, a data source edit control, a data range selection control, or a view display type selection control, and the data range selection control includes a work item selection sub-control.

On the basis of the above technical solutions, the target data source determination module 510 is specifically configured to determine the at least one work item and the associated data based on an edit operation on the edit page.

On the basis of the above technical solutions, the edit page includes a data source edit control, and the target data source determination module 510 includes: a target data source edit unit and a work item determination unit.

The target data source edit unit is configured to edit at least two target data sources in the data source edit control.

The work item determination unit is configured to determine the at least one work item based on the at least two target data sources and the corresponding at least one work item to be selected.

On the basis of the above technical solutions, the work item determination unit is specifically configured to determine the at least one work item based on the at least two target data sources and a target data source to which the at least one work item to be selected belongs.

On the basis of the above technical solutions, the edit page includes a data range selection control, and the target data source determination module 510 further includes: a list display unit, a data source trigger unit, a work item to be selected determination unit, and a work item trigger unit.

The list display unit is configured to display a work item display list in response to a trigger operation of the work item selection sub-control in the data range selection control being detected.

The data source trigger unit is configured to use a data source triggered to be selected in the work item display list as the target data source.

The work item to be selected determination unit is configured to display at least one work item to be selected associated with the target data source after it is detected that the target data source is determined.

The work item trigger unit is configured to determine the at least one work item based on a trigger operation and/or a search operation for the work item to be selected.

On the basis of the above technical solutions, the work item display list displays at least one data source with access permission and a corresponding work item to be selected.

On the basis of the above technical solutions, the apparatus further includes: a historical data display module.

The historical data display module is configured to store the target data source and the corresponding at least one work item as a piece of historical data, to display the historical data in response to the view creation operation being received again.

On the basis of the above technical solutions, the target view display module 530 includes: a target work item determination unit, an associated data determination unit, and a target view determination unit.

The target work item determination unit is configured to perform aggregation on a field of the at least one work item to obtain at least one target work item.

The associated data determination unit is configured to determine the associated data corresponding to the at least one target work item.

The target view determination unit is configured to draw the associated data according to the target view display type that is pre-selected to obtain the target view.

On the basis of the above technical solutions, the target work item determination unit includes a target work item determination first unit, a fused field determination unit, and a target work item determination second unit.

The target work item determination first unit is configured to perform aggregation on the field of the at least one work item according to a preset aggregation rule to obtain the at least one target work item.

The fused field determination unit is configured to determine a fused field based on a trigger operation on an aggregated field of the at least one work item.

The target work item determination second unit is configured to determine the at least one target work item based on the fused field.

On the basis of the above technical solutions, the apparatus further includes: a data source identifier display module.

The data source identifier display module is configured to display an identifier according to the at least two target data sources in the target view.

In the technical solutions of the embodiment of the present disclosure, the at least two target data sources and the at least one work item corresponding to the target data sources are edited in response to the view creation operation; the associated data corresponding to the at least one work item associated with the at least two target data sources is retrieved; and the target view is determined and displayed based on the associated data and the target view display type that is predetermined. Therefore, the problem of low management efficiency caused by viewing the project information under each application one by one for project management is solved, and by retrieving the associated data corresponding to the multiple work items under each application after the view creation function is initiated, and integrating and displaying the associated data of the plurality of applications in the form of a view, data display across applications is implemented, and users can clearly learn the project information between the applications based on the displayed view, so as to implement the joint management of the plurality of applications, improve the management efficiency, and achieve a technical effect of meeting the management needs of the users.

The data processing apparatus provided in the embodiment of the present disclosure may execute the data processing method provided in any embodiment of the present disclosure, and has function modules and beneficial effects corresponding to the execution of the method.

It is worth noting that the units and modules included in the above apparatus are only divided according to functional logic, but are not limited to the above division, as long as the corresponding functions can be implemented. In addition, the specific names of the functional units are only for the convenience of distinguishing each other, and are not intended to limit the protection scope of the embodiments of the present disclosure.

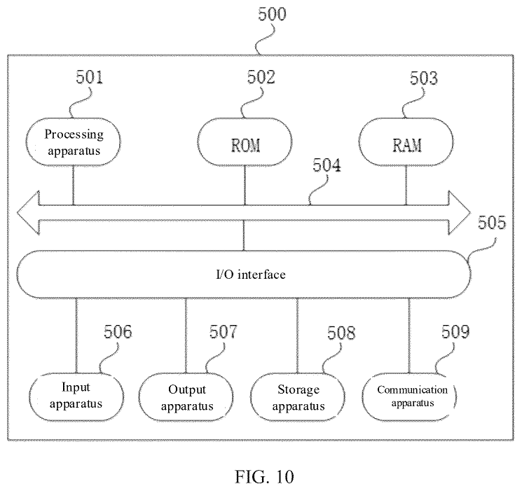

FIG. 10 is a schematic structural diagram of an electronic device provided by an embodiment of the present disclosure. Reference is made to FIG. 10 below, which shows a schematic structural diagram of an electronic device 500 (such as a terminal device or a server in FIG. 10) applicable to implementing an embodiment of the present disclosure. The terminal device in the embodiment of the present disclosure may include but not limited to a mobile terminal such as a mobile phone, a notebook computer, a digital broadcast receiver, a PDA (personal digital assistant), a PAD (tablet computer), a PMP (portable multimedia player), an in-vehicle terminal (such as an in-vehicle navigation terminal), etc., and a fixed terminal such as a digital TV, a desktop computer, etc. The electronic device shown in FIG. 10 is only an example, and shall not impose any limitation on the function and scope of use of the embodiments of the present disclosure.

As shown in FIG. 10, the electronic device 500 may include a processing apparatus (such as a central processing unit, a graphics processing unit, etc.) 501, which may perform various appropriate actions and processes according to a program stored in a read-only memory (ROM) 502 or a program loaded from a storage apparatus 508 to a random access memory (RAM) 503. The RAM 503 also stores various programs and data required for the operation of the electronic device 500. The processing apparatus 501, the ROM 502 and the RAM 503 are connected to each other through a bus 504. An input/output (I/O) interface 505 is also connected to the bus 504.

Generally, the following apparatuses may be connected to the I/O interface 505: an input apparatus 506 including, for example, a touch screen, a touch pad, a keyboard, a mouse, a camera, a microphone, an accelerometer, a gyroscope, or the like; an output apparatus 507 including, for example, a liquid crystal display (LCD), a speaker, a vibrator, or the like; a storage apparatus 508 including, for example, a magnetic tape, a hard disk, or the like; and a communication apparatus 509. The communication apparatus 509 may allow the electronic device 500 to perform wireless or wired communication with other devices to exchange data. Although FIG. 10 shows the electronic device 500 having various apparatuses, it should be understood that it is not required to implement or have all the apparatuses shown. More or fewer apparatuses may alternatively be implemented or provided.

In particular, according to an embodiment of the present disclosure, the process described above with reference to the flowchart may be implemented as a computer software program. For example, an embodiment of the present disclosure includes a computer program product, which includes a computer program carried on a non-transitory computer-readable medium, where the computer program includes program code for executing the method shown in the flowchart. In such an embodiment, the computer program may be downloaded and installed from a network through the communication apparatus 509, or installed from the storage apparatus 508, or installed from the ROM 502. When the computer program is executed by the processing apparatus 501, the above functions defined in the method of the embodiment of the present disclosure are performed.

The names of messages or information exchanged between a plurality of apparatuses in the implementations of the present disclosure are only for illustrative purposes, and are not intended to limit the scope of the messages or information.

The electronic device provided in the embodiment of the present disclosure belongs to the same inventive concept as the data processing method provided in the above embodiments. For the technical details not described in detail in this embodiment, reference may be made to the above embodiments, and this embodiment has the same beneficial effects as the above embodiments.

An embodiment of the present disclosure provides a computer storage medium on which a computer program is stored, and when the program is executed by a processor, the data processing method provided in the above embodiments is implemented.

It should be noted that the above computer-readable medium in the present disclosure may be a computer-readable signal medium or a computer-readable storage medium, or any combination thereof. The computer-readable storage medium may be, for example, but not limited to, an electrical, magnetic, optical, electromagnetic, infrared, or semiconductor system, apparatus, or device, or any combination of the above. More specific examples of the computer-readable storage medium may include, but are not limited to, an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium that contains or stores a program which may be used by or in combination with an instruction execution system, apparatus, or device. In the present disclosure, the computer-readable signal medium may include a data signal propagated in a baseband or as a part of a carrier, in which a computer-readable program code is carried. The data signal propagated in this manner may take a variety of forms, including but not limited to an electromagnetic signal, an optical signal, or any suitable combination of the above. The computer-readable signal medium may also be any computer-readable medium other than the computer-readable storage medium, and the computer-readable signal medium may send, propagate, or transmit a program used by or in combination with an instruction execution system, apparatus, or device. The program code contained in the computer-readable medium may be transmitted by any suitable medium, including but not limited to an electric wire, an optical cable, RF (radio frequency), etc., or any suitable combination of the above.

In some implementations, the client and the server may communicate using any currently known or future-developed network protocol such as HTTP (HyperText Transfer Protocol), and may be interconnected with digital data communication (for example, a communication network) in any form or medium. Examples of the communication network include a local area network (“LAN”), a wide area network (“WAN”), an internet (for example, the Internet), and an end-to-end network (for example, an ad hoc end-to-end network), as well as any currently known or future-developed network.

The above computer-readable medium may be included in the above electronic device, or may exist alone without being assembled into the electronic device.

The above computer-readable medium carries one or more programs, and when the one or more programs are executed by the electronic device, the electronic device is caused to:

edit at least two target data sources and at least one work item corresponding to the target data sources in response to a view creation operation; retrieve associated data corresponding to the at least one work item associated with the at least two target data sources; and determine and display a target view based on the associated data and a target view display type that is predetermined.

Alternatively, the above computer-readable medium carries one or more programs, and when the one or more programs are executed by the electronic device, the electronic device is caused to:

edit at least two target data sources and at least one work item corresponding to the target data sources in response to a view creation operation; retrieve associated data corresponding to the at least one work item associated with the at least two target data sources; and determine and display a target view based on the associated data and a target view display type that is predetermined.

The computer program code for performing the operations of the present disclosure may be written in one or more programming languages or a combination thereof. The above programming languages include object-oriented programming languages such as Java, Smalltalk, C++, and also include conventional procedural programming languages such as the “C” language or similar programming languages. The program code may be executed entirely on the user's computer, partly on the user's computer, as a stand-alone software package, partly on the user's computer and partly on a remote computer, or entirely on the remote computer or the server. In the case where the remote computer is involved, the remote computer may be connected to the user's computer through any type of network, including a local area network (LAN) or a wide area network (WAN), or the connection may be made to an external computer (for example, through the Internet using an Internet service provider).

The flowcharts and block diagrams in the drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the drawings. For example, two blocks shown in succession may, in fact, be executed substantially concurrently, or the blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may be implemented by a combination of dedicated hardware and computer instructions.

The units involved in the embodiments of the present disclosure may be implemented by software or hardware. Names of the units do not constitute a limitation on the units themselves in a certain case.

For example, a first obtaining unit may also be described as “a unit for obtaining at least two Internet protocol addresses”.

The functions described herein above may be performed, at least partially, by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logic device (CPLD), etc.

In the context of the present disclosure, the machine-readable medium may be a tangible medium, which may include or store a program for use by or in combination with an instruction execution system, apparatus, or device. The machine-readable medium may be a machine-readable signal medium or a machine-readable storage medium. The machine-readable medium may include but not be limited to an electronic, magnetic, optical, electromagnetic, infrared, or semiconductor system, apparatus, or device, or any suitable combination of the above. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

The above description is only preferred embodiments of the present disclosure and an illustration of the applied technical principles. Those skilled in the art should understand that the disclosure scope involved in the present disclosure is not limited to the technical solutions formed by a specific combination of the above technical features, and should also cover other technical solutions formed by any combination of the above technical features or equivalent features thereof without departing from the above disclosed concept. For example, a technical solution formed by replacing the above features with technical features with similar functions disclosed in the present disclosure (but not limited to).

In addition, although operations are depicted in a particular order, it should not be understood that these operations are required to be performed in the particular order shown or in a sequential order. Under certain circumstances, multitasking and parallel processing may be advantageous. Similarly, although several specific implementation details are included in the above discussion, these should not be interpreted as limiting the scope of the present disclosure. Certain features described in the context of separate embodiments may also be implemented in combination in a single embodiment. Conversely, various features described in the context of a single embodiment may also be implemented in multiple embodiments separately or in any suitable sub-combination.

Although the subject matter has been described in language specific to structural features and/or logical actions of the method, it should be understood that the subject matter defined in the appended claims is not necessarily limited to the specific features or actions described above. On the contrary, the specific features and actions described above are only exemplary forms for implementing the claims.

1. A data processing method, comprising:
editing at least two target data sources and at least one work item corresponding to the target data sources in response to a view creation operation;
retrieving associated data corresponding to the at least one work item associated with the at least two target data sources; and
determining and displaying a target view based on the associated data and a target view display type that is predetermined.

2. The data processing method according to claim 1, wherein after responding to the view creation operation, the data processing method further comprises:
displaying an edit page,
wherein the edit page comprises at least one of a view name edit control, a data source edit control, a data range selection control, and a view display type selection control,
the data range selection control comprises a work item selection sub-control.

3. The data processing method according to claim 2, wherein editing the at least two target data sources and the at least one work item corresponding to the target data sources comprises:
determining the at least one work item and the associated data based on an edit operation on the edit page.

4. The data processing method according to claim 3, wherein the edit page comprises the data source edit control, and editing the at least two target data sources and the at least one work item corresponding to the target data sources comprises:
editing the at least two target data sources in the data source edit control; and
determining the at least one work item based on the at least two target data sources and at least one work item to be selected.

5. The data processing method according to claim 4, wherein determining the at least one work item based on the at least two target data sources and the at least one work item to be selected comprises:
determining the at least one work item based on the at least two target data sources and a target data source to which the at least one work item to be selected belongs.

6. The data processing method according to claim 3, wherein the edit page comprises the data range selection control, and editing the at least two target data sources and the at least one work item corresponding to the target data sources comprises:
displaying a work item display list in response to a trigger operation of the work item selection sub-control in the data range selection control being detected;
using a data source triggered to be selected in the work item display list as the target data source;
displaying at least one work item to be selected associated with the target data source after it is detected that the target data source is determined; and
determining the at least one work item based on a trigger operation and/or a search operation for the work item to be selected.

7. The data processing method according to claim 6, wherein the work item display list displays at least one data source with access permission and a corresponding work item to be selected.

8. The data processing method according to claim 4, further comprising:
storing the target data source and the at least one work item as a piece of historical data, to display the historical data in response to the view creation operation being received again.

9. The data processing method according to claim 1, wherein determining the target view based on the associated data and the target view display type that is predetermined comprises:
performing aggregation on a field of the at least one work item to obtain at least one target work item;
determining the associated data corresponding to the at least one target work item; and
drawing the associated data according to the target view display type that is pre-selected to obtain the target view.

10. The data processing method according to claim 9, wherein performing aggregation on the field of the at least one work item to obtain the at least one target work item comprises:
performing aggregation on the field of the at least one work item according to a preset aggregation rule to obtain the at least one target work item; or,
determining a fused field based on a trigger operation on an aggregated field of the at least one work item, and determining the at least one target work item based on the fused field.

11. The data processing method according to claim 1, further comprising:
displaying a data source identifier corresponding to the at least two target data sources in the target view.

12. (canceled)

13. An electronic device, comprising:
at least one processor and
at least one storage apparatus configured to store one or more programs,
wherein the one or more programs, when executed by the at least one processor cause the one or more processors to implement a data processing method and the method comprises:
editing at least two target data sources and at least one work item corresponding to the target data sources in response to a view creation operation;
retrieving associated data corresponding to the at least one work item associated with the at least two target data sources; and
determining and displaying a target view based on the associated data and a target view display type that is predetermined.

14. A non-transitory storage medium comprising computer-executable instructions, wherein the computer-executable instructions, when executed by a computer processor, implement a data processing method and the method comprises:
editing at least two target data sources and at least one work item corresponding to the target data sources in response to a view creation operation;
retrieving associated data corresponding to the at least one work item associated with the at least two target data sources; and
determining and displaying a target view based on the associated data and a target view display type that is predetermined.

15. The data processing method according to claim 6, further comprising:
storing the target data source and the at least one work item as a piece of historical data, to display the historical data in response to the view creation operation being received again.

16. The electronic device according to claim 13, wherein after responding to the view creation operation, the data processing method further comprises:
displaying an edit page,
wherein the edit page comprises at least one of a view name edit control, a data source edit control, a data range selection control, and a view display type selection control,
the data range selection control comprises a work item selection sub-control.

17. The electronic device according to claim 16, wherein editing the at least two target data sources and the at least one work item corresponding to the target data sources comprises:
determining the at least one work item and the associated data based on an edit operation on the edit page.

18. The electronic device according to claim 17, wherein the edit page comprises the data source edit control, and editing the at least two target data sources and the at least one work item corresponding to the target data sources comprises:
editing the at least two target data sources in the data source edit control; and
determining the at least one work item based on the at least two target data sources and at least one work item to be selected.

19. The electronic device according to claim 18, wherein determining the at least one work item based on the at least two target data sources and the at least one work item to be selected comprises:
determining the at least one work item based on the at least two target data sources and a target data source to which the at least one work item to be selected belongs.

20. The electronic device according to claim 17, wherein the edit page comprises the data range selection control, and editing the at least two target data sources and the at least one work item corresponding to the target data sources comprises:
displaying a work item display list in response to a trigger operation of the work item selection sub-control in the data range selection control being detected;
using a data source triggered to be selected in the work item display list as the target data source;
displaying at least one work item to be selected associated with the target data source after it is detected that the target data source is determined; and
determining the at least one work item based on a trigger operation and/or a search operation for the work item to be selected.

21. The electronic device according to claim 20, wherein the work item display list displays at least one data source with access permission and a corresponding work item to be selected.
